(19) United States
(12) Patent Application Publication
(10) Pub. No.: US 2024/0342513 A1
(43) Pub. Date: Oct. 17, 2024

(54) EMERGENCY OXYGEN SYSTEMS FOR INTERNAL CABINS OF AIRCRAFT

(71) Applicant: THE BOEING COMPANY, Arlington, VA (US)

(72) Inventors: Andrew Leo Fabry, Seattle, WA (US); Adam Patrick Boroughs, Seattle, WA (US); Katia Marguerite Benson, Everett, WA (US); Douglas Alan Brown, Edmonds, WA (US); Franco Marino Cagnina, Lynnwood, WA (US)

(73) Assignee: THE BOEING COMPANY, Arlington, VA (US)

(21) Appl. No.: 18/301,326

(22) Filed: Apr. 17, 2023

(51) Int. Cl. A62B 7/14; A62B 25/00; B64D 11/00

(52) U.S. Cl. CPC A62B 7/14; A62B 25/005; B64D 11/00; B64D 2231/025

(57) ABSTRACT

An emergency oxygen system for an internal cabin of a vehicle includes a housing including one or more compartments, and one or more oxygen assemblies. The one or more oxygen assemblies include a mask and a fluid conduit. The mask is configured to be stowed within and deployed from the one or more compartments. A door is moveably secured to the housing. The door is moveable between a closed position underneath the one or more compartments to secure the mask within the one or more compartments, and an open position during a deployment event in which the mask drops down and laterally out of the one or more compartments. The mask is configured to hang down from a portion of the door when the door is in the open position. The emergency oxygen assemblies can be separate and distinct from passenger service units (PSUs).

### FIELD OF THE DISCLOSURE

Embodiments of the present disclosure generally relate to emergency oxygen systems for internal cabins of aircraft.

### BACKGROUND OF THE DISCLOSURE

Vehicles such as commercial aircraft are used to transport passengers between various locations. Emergency oxygen assemblies are provided within internal cabins of commercial aircraft. In the event of a predetermined depressurization within an internal cabin, the emergency oxygen assemblies are configured to deploy so that passengers are able to breathe therefrom.

Typically, the emergency oxygen assemblies, including masks and conduits, are housed within passenger service units (PSUs), which are disposed above seats within the internal cabin. As can be appreciated, the emergency oxygen assemblies occupy space within the PSUs, thereby precluding other components from being housed within the PSUs.

Additionally, internal cabins of certain commercial aircraft can be reconfigured as desired. For example, spacing or pitch between seats within the internal cabin can be changed. After reconfiguration, the emergency oxygen assemblies within the PSUs may not be aligned with respective seats. Accordingly, additional time and labor is typically required to adjust the emergency oxygen assemblies in relation to the reconfigured seats.

### SUMMARY OF THE DISCLOSURE

A need exists for a system and method for freeing up space within PSUs. Further, a need exists for ensuring emergency oxygen assemblies are easily and readily available within an internal cabin of an aircraft even if seats within the internal cabin are reconfigured (for example, seat pitch between at least two seats may change).

With those needs in mind, certain embodiments provide a vehicle including an internal cabin, a plurality of passenger service units (PSUs) within the internal cabin, and an emergency oxygen system within the internal cabin. The emergency oxygen system is separate and distinct from the plurality of PSUs.

In at least one embodiment, the emergency oxygen system includes a plurality of oxygen assemblies. In at least one embodiment, the plurality of oxygen assemblies are uncoupled from seat pitch. In at least one embodiment, each of the plurality of oxygen assemblies includes a mask and a fluid conduit.

In at least one embodiment, the emergency oxygen system further includes an oxygen supply in fluid communication with the plurality of oxygen assemblies. For example, the oxygen supply includes an oxygen canister fluidly coupled to the fluid conduit. As another example, the oxygen supply includes an oxygen tank fluid coupled to a plurality of fluid conduits via a manifold.

In at least one embodiment, the emergency oxygen system further includes a rail (or an array of rails) extending along a length of the internal cabin. The rail(s) retains the plurality of oxygen assemblies.

The emergency oxygen system can be disposed between a sidewall of the vehicle and the plurality of PSUs.

In at least one embodiment, a partition wall separates the emergency oxygen system from the plurality of PSUs.

In at least one embodiment, one or more stowage bin assemblies are within the internal cabin. One or more of the plurality of PSUs are disposed between the one or more stowage bin assemblies and the emergency oxygen system.

Certain embodiments of the present disclosure provide a method including providing a plurality of passenger service units (PSUs) within an internal cabin of a vehicle, and providing an emergency oxygen system within the internal cabin, wherein the emergency oxygen system is separate and distinct from the plurality of PSUs.

Certain embodiments of the present disclosure provide an emergency oxygen system for an internal cabin of a vehicle. The emergency oxygen system includes a housing including one or more compartments, and one or more oxygen assemblies. The one or more oxygen assemblies include a mask and a fluid conduit. The mask is configured to be stowed within and deployed from the one or more compartments. A door is moveably secured to the housing. The door is moveable between a closed position underneath the one or more compartments to secure the mask within the one or more compartments, and an open position during a deployment event in which the mask drops down and laterally left or right (such as inboard) out of the one or more compartments. The mask is configured to hang down from a portion of the door when the door is in the open position. In at least one example, the door is configured to rotate between the closed position and the open position.

In at least one example, the mask is supported on an interior surface of the door when the door is in the closed position.

In at least one example, at least a portion of the fluid conduit is secured to an interior surface of the door. For example, the door includes one or more clips secured to the interior surface. The portion(s) of the fluid conduit is secured to the interior surface of the door by the one or more clips.

In at least one example, one or more retainers are coupled to the one or more compartments. The one or more retainers are moveable between a retaining position in which the one or more retainers temporarily support the mask within the one or more compartments when the door is the open position, and a disengaged position in which the one or more retainers do not support the mask within the one or more compartments. As a further example, a portion of the door moves the one or more retainers from the retaining position to the disengaged position when the door moves into the closed position. The one or more retainers can include one or more arms pivotally coupled to one or more portions of the one or more compartments. As another example, the one or more retainers comprise one or more snap clips.

In at least one example, the one or more compartments include a plurality of compartments, and the one or more oxygen assemblies include a plurality of oxygen assemblies.

Certain embodiments of the present disclosure provide a method including stowing a mask of one or more oxygen assemblies within one or more compartments of a housing of an emergency oxygen system; and moving a door secured to the housing between a closed position underneath the one or more compartments to secure the mask within the one or more compartments, and an open position during a deployment event in which the mask drops down and laterally (such as inboard) out of the one or more compartments, and wherein the mask is configured to hang down from a portion of the door when the door is in the open position.

Certain embodiments of the present disclosure provide a vehicle including an internal cabin, and an emergency oxygen system within the internal cabin, as described herein.

### BRIEF DESCRIPTION OF THE DRAWINGS

FIG. 1 illustrates a schematic block diagram of an emergency oxygen system within an internal cabin of an aircraft, according to an embodiment of the present disclosure.

FIG. 2 illustrates a perspective front view of an aircraft, according to an embodiment of the present disclosure.

FIG. 3A illustrates a top plan view of an internal cabin of an aircraft, according to an embodiment of the present disclosure.

FIG. 3B illustrates a top plan view of an internal cabin of an aircraft, according to an embodiment of the present disclosure.

FIG. 4 illustrates a perspective interior view of an internal cabin of an aircraft, according to an embodiment of the present disclosure.

FIG. 5 illustrates a schematic block diagram of an oxygen supply coupled to an oxygen assembly, according to an embodiment of the present disclosure.

FIG. 6 illustrates a schematic block diagram of an oxygen supply coupled to a plurality of oxygen assemblies, according to an embodiment of the present disclosure.

FIG. 7 illustrates a perspective internal view of an internal cabin of an aircraft, according to an embodiment of the present disclosure.

FIG. 8 illustrates an axial cross-sectional view of an internal cabin of an aircraft, according to an embodiment of the present disclosure.

FIG. 9 illustrates an axial cross-sectional view of an oxygen assembly of an emergency oxygen system within an internal cabin, according to an embodiment of the present disclosure.

FIG. 10 illustrates a lateral view of an emergency oxygen system within an internal cabin, according to an embodiment of the present disclosure.

FIG. 11 illustrates a perspective lateral view of an emergency oxygen system within an internal cabin, according to an embodiment of the present disclosure.

FIG. 12 illustrates a flow chart of a method, according to an embodiment of the present disclosure.

FIG. 13 illustrates a perspective lateral bottom view of an emergency oxygen system having oxygen assemblies in deployed positions, according to an embodiment of the present disclosure.

FIG. 14 illustrates a perspective bottom view of the emergency oxygen system of FIG. 13 having the oxygen assemblies in the deployed positions.

FIG. 15 illustrates a perspective bottom view of a door in an open position, according to an embodiment of the present disclosure.

FIG. 16 illustrates a perspective lateral bottom view of an open compartment, according to an embodiment of the present disclosure.

FIG. 17 illustrates a perspective fore bottom view of the open compartment.

FIG. 18 illustrates a perspective end view of an emergency oxygen system, according to an embodiment of the present disclosure.

FIG. 19 illustrates a flow chart of a method, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

As described herein, embodiments of the present disclosure provide an emergency oxygen system that is separate and distinct from passenger service units (PSUs) within an internal cabin of an aircraft. In particular, oxygen assemblies of the system are uncoupled from the PSUs. The oxygen assemblies are not within the PSUs. Further, the oxygen assemblies are uncoupled from seat pitch. That is, locations of the oxygen assemblies are not dependent upon seat pitch.

Separating the emergency oxygen system from the PSUs allows for easier seat reconfiguration within the internal cabin and shorter pitch between seats. Further, the emergency oxygen systems described herein reduce variability in configurations, thereby reducing recurring engineering time and subsequent costs. Also, embodiments of the present disclosure increase available space within PSUs, thereby allowing for additional components therein.

In at least one embodiment, the emergency oxygen system includes a rail (or an array of rails) that extends over a length of the internal cabin. The rail(s) is separated from the PSUs. The rail(s) includes the oxygen assemblies, such as may include masks and fluid conduits, which are in fluid communication with an oxygen supply.

In at least one embodiment, the oxygen assemblies are longitudinally arrayed along a length of the internal cabin. The oxygen assemblies are spaced apart to ensure passengers within the internal cabin have access thereto, regardless of the pitch between seat assemblies. For example, the internal cabin can be reconfigured to change pitch between seat assemblies and oxygen assemblies are still readily and easily available for each seat within the internal cabin.

As described herein, in at least one example, the emergency oxygen system is separated from PSUs, which allows for masks to be linearly arranged along a length of the internal cabin. In stowed positions, each mask is housed in a box or other such compartment. A door covers the compartment in a closed position. The door can be spring-loaded, such that during an emergency, the door moves into an open position, such as by rotating 180 degrees, and the masks deploy out of the compartments. In at least one example, the masks are hung from the door by tubing of fluid conduits. In the deployed positions, the masks hang inboard in relation to the compartments (instead of dropping straight down from the compartments), thereby providing better reach for passengers and flight attendants.

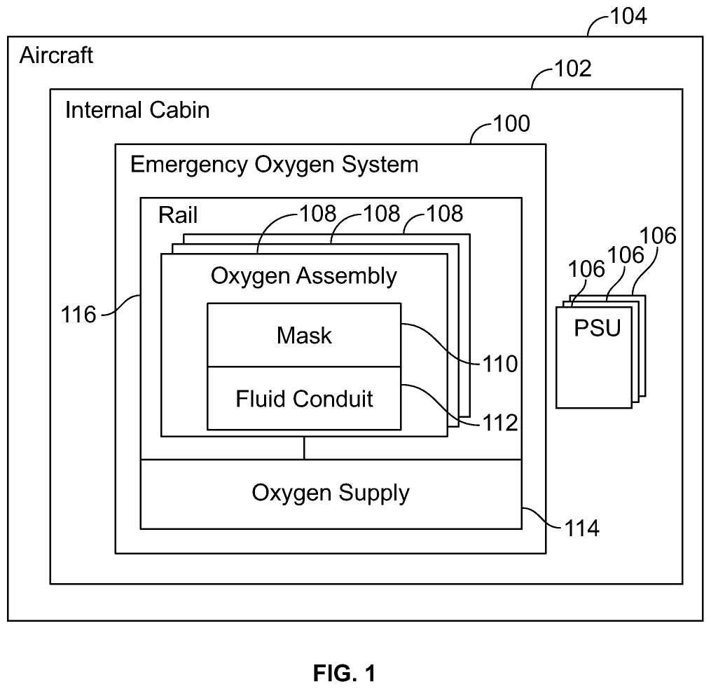

FIG. 1 illustrates a schematic block diagram of an emergency oxygen system 100 within an internal cabin 102 of an aircraft 104, according to an embodiment of the present disclosure. The emergency oxygen system 100 is separate and distinct from personal service units (PSUs) 106 within the internal cabin 102. In particular, the PSUs 106 do not include the emergency oxygen system 100, and vice versa.

The emergency oxygen system 100 includes a plurality of oxygen assemblies 108. The oxygen assemblies 108 include a mask 110 and a fluid conduit 112. During a sudden cabin depressurization, the oxygen assemblies 108 are configured to deploy (such as drop down). An oxygen supply 114 is in fluid communication with the fluid conduits 112. In at least one embodiment, each oxygen assembly 108 is in fluid communication with a respective oxygen supply 114, such as an oxygen canister fluidly coupled to the fluid conduit 112. In at least one other embodiment, an oxygen supply 114 such as an oxygen tank or cylinder is in fluid communication with a plurality of fluid conduits 112 of oxygen assemblies 108, such as via a manifold.

In at least one embodiment, the emergency oxygen system 100 includes a rail 116 that extends along a length of the internal cabin 102. The rail 116 can be a single rail or an array of rails, for example. The rail 116 retains the oxygen assemblies 108, such as at a position above and/or to the side of seats within the internal cabin 102. At least a portion of the oxygen supply 114 may also be retained by the rail 116. Optionally, the rail 116 does not retain the oxygen supply 114. Also, optionally, the emergency oxygen system 100 may not include the rail 116. Instead, the oxygen assemblies 108 may be secured to portions of the internal cabin (such as side walls, a ceiling, a floor, or the like) within the use of a rail.

The oxygen assemblies 108 are separate and distinct from the PSUs 106. The oxygen assemblies 108 are uncoupled from the PSUs 106. The PSUs 106 do not include the oxygen assemblies 108.

As described herein, a vehicle (such as the aircraft 104) includes the internal cabin 102. A plurality of PSUs 106 are within the internal cabin 102. The emergency oxygen system 100 is within the internal cabin 102. The emergency oxygen system 100 is separate and distinct from the plurality of PSUs 106.

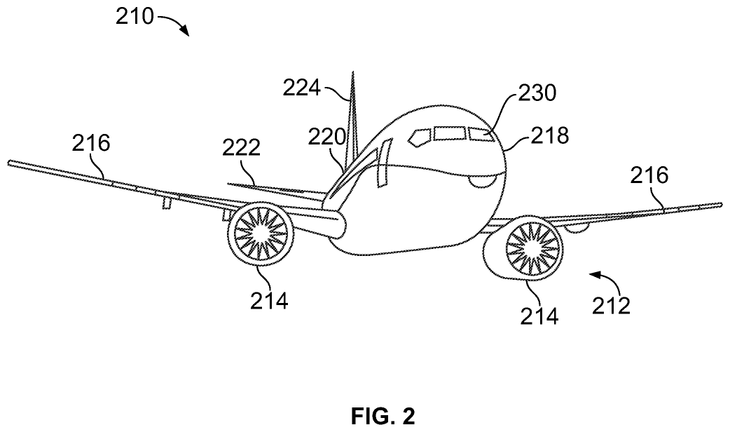

FIG. 2 illustrates a perspective front view of an aircraft 210, according to an embodiment of the present disclosure. The aircraft 210 is an example of the aircraft 104, shown in FIG. 1. The aircraft 210 includes a propulsion system 212 that includes engines 214, for example. Optionally, the propulsion system 212 may include more engines 214 than shown. The engines 214 are carried by wings 216 of the aircraft 210. In other embodiments, the engines 214 may be carried by a fuselage 218 and/or an empennage 220. The empennage 220 may also support horizontal stabilizers 222 and a vertical stabilizer 224.

The fuselage 218 of the aircraft 210 defines an internal cabin 230, which includes a flight deck or cockpit, one or more work sections (for example, galleys, personnel carry-on baggage areas, and the like), one or more passenger sections (for example, first class, business class, and coach sections), one or more lavatories, and/or the like. The internal cabin 230 is an example of the internal cabin 102, as shown in FIG. 1.

Alternatively, instead of an aircraft, embodiments of the present disclosure may be used with various other vehicles, such as automobiles, buses, locomotives and train cars, watercraft, and the like. Further, embodiments of the present disclosure may be used with respect to fixed structures, such as commercial and residential buildings.

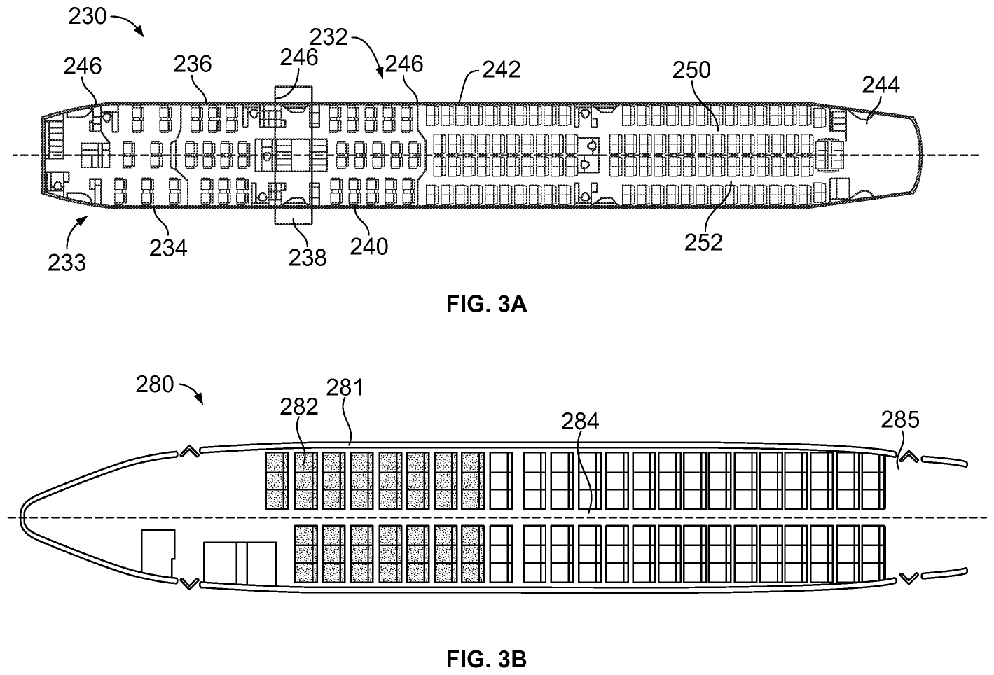

FIG. 3A illustrates a top plan view of an internal cabin 230 of an aircraft, according to an embodiment of the present disclosure. The internal cabin 230 may be within the fuselage 232 of the aircraft, such as the fuselage 218 of FIG. 2. For example, one or more fuselage walls may define the internal cabin 230. The internal cabin 230 includes multiple areas, including a front section 233, a first-class section 234, a business class section 236, a front galley station 238, an expanded economy or coach section 240, a standard economy of coach section 242, and an aft section 244. It is to be understood that the internal cabin 230 may include more or less areas than shown. For example, the internal cabin 230 may not include a first-class section, and may include more or less galley stations than shown. Each of the sections may be separated by a cabin transition area 246, which may include class divider assemblies between aisles.

As shown in FIG. 3A, the internal cabin 230 includes two aisles 250 and 252 that lead to the aft section 244. Optionally, the internal cabin 230 may have fewer or more aisles than shown. For example, the internal cabin 230 may include a single aisle that extends through the center of the internal cabin 230 that leads to the aft section 244.

The emergency oxygen system 100 shown in FIG. 1 can be disposed within the internal cabin 230. For example, the rail 116 can extend along a length of the internal cabin 230.

FIG. 3B illustrates a top plan view of an internal cabin 280 of an aircraft, according to an embodiment of the present disclosure. The internal cabin 280 is an example of the internal cabin 230 shown in FIG. 2. The internal cabin 280 may be within a fuselage 281 of the aircraft. For example, one or more fuselage walls may define the internal cabin 280. The internal cabin 280 includes multiple areas, including a main cabin 282 having passenger seats, and an aft section 285 behind the main cabin 282. It is to be understood that the internal cabin 280 may include more or less areas than shown.

The internal cabin 280 may include a single aisle 284 that leads to the aft section 285. The single aisle 284 may extend through the center of the internal cabin 280 that leads to the aft section 285. For example, the single aisle 284 may be coaxially aligned with a central longitudinal plane of the internal cabin 280.

The emergency oxygen system 100 shown in FIG. 1 can be disposed within the internal cabin 280. For example, the rail 116 can extend along a length of the internal cabin 280.

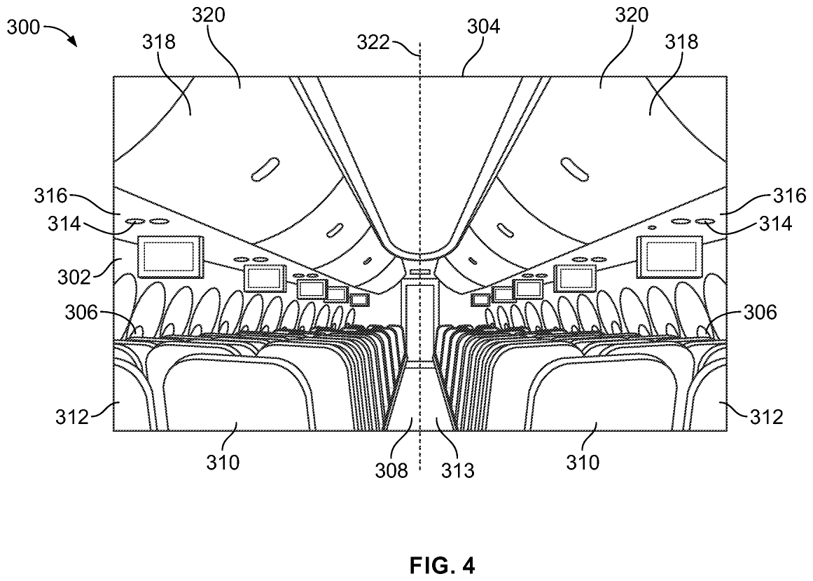

FIG. 4 illustrates a perspective interior view of an internal cabin 300 of an aircraft, according to an embodiment of the present disclosure. The internal cabin 300 is an example of the internal cabin 102 shown in FIG. 1. The internal cabin 300 includes outboard walls 302 and a ceiling 304. Windows 306 may be formed within the outboard walls 302. A floor 308 supports rows of seats 310. As shown in FIG. 4, a row 312 may include two seats 310 on either side of an aisle 313. However, the row 312 may include more or less seats 310 than shown. Additionally, the internal cabin 300 may include more aisles than shown.

PSUs 314 are secured between an outboard wall 302 and the ceiling 304 and/or stowage bin assemblies 318 on either side of the aisle 313. The PSUs 314 extend between a front end and rear end of the internal cabin 300. For example, a PSU 314 may be positioned over each seat 310 within a row 312. Each PSU 314 may include a housing 316 that generally contains vents, reading lights, an attendant request button, and other such controls over each seat 310 (or groups of seats) within a row 312. Notably, the PSUs 314 do not include the oxygen assemblies 108 shown in FIG. 1.

Overhead stowage bin assemblies 318 are secured to the ceiling 304 and/or the outboard wall 302 above and inboard from the PSU 314 on either side of the aisle 313. The overhead stowage bin assemblies 318 are secured over the seats 310. The overhead stowage bin assemblies 318 extend between the front and rear end of the internal cabin 300. Each stowage bin assembly 318 may include a pivot bin or bucket 320 pivotally secured to a strongback. The overhead stowage bin assemblies 318 may be positioned above and inboard from lower surfaces of the PSUs 314. The overhead stowage bin assemblies 318 are configured to be pivoted open in order to receive passenger carry-on baggage and personal items, for example.

As used herein, the term “outboard” means a position that is further away from a central longitudinal plane 322 of the internal cabin 300 as compared to another component. The term “inboard” means a position that is closer to the central longitudinal plane 322 of the internal cabin 300 as compared to another component. For example, a lower surface of a PSU 314 may be outboard in relation to a stowage bin assembly 318.

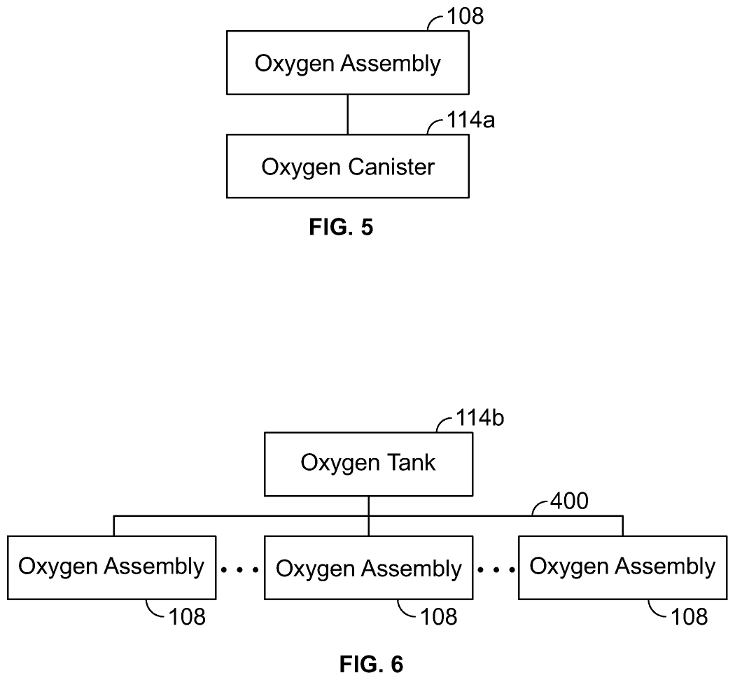

FIG. 5 illustrates a schematic block diagram of an oxygen supply 114a coupled to an oxygen assembly 108, according to an embodiment of the present disclosure. As shown, each oxygen assembly 108 can be coupled to a respective oxygen supply 114a, such as an oxygen canister in direct fluid communication with the fluid conduit 112 (shown in FIG. 1).

FIG. 6 illustrates a schematic block diagram of an oxygen supply 114b coupled to a plurality of oxygen assemblies 108, according to an embodiment of the present disclosure. For example, the oxygen supply 114b is an oxygen tank or cylinder in fluid communication with a plurality of oxygen assemblies 108 through a fluid manifold 400. Referring to FIGS. 1 and 6, a single oxygen supply 114b can be in fluid communication with all of the oxygen assemblies 108 within the internal cabin 102. Optionally, multiple oxygen supplies 114b can be located within the internal cabin 102, each of which can be in fluid communication with a subset of the oxygen assemblies 108.

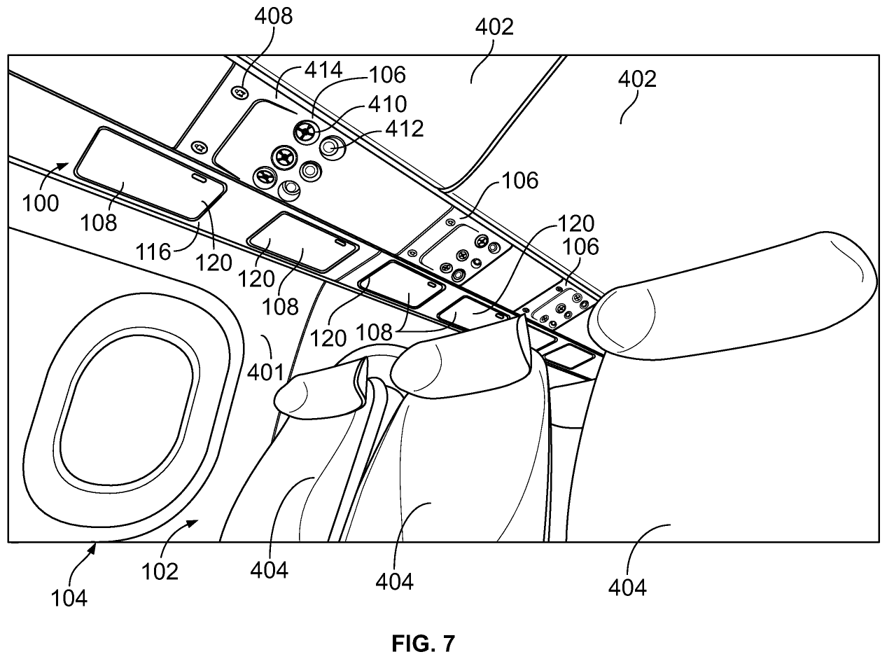

FIG. 7 illustrates a perspective internal view of an internal cabin 102 of an aircraft 104, according to an embodiment of the present disclosure. As shown, the emergency oxygen system 100 includes the rail 116 that extends along a length of the internal cabin 102. The rail 116 retains the oxygen assemblies 108, such as may include oxygen drop panels 120. Referring to FIGS. 1 and 7, the masks 110 and fluid conduits 112 are disposed above the oxygen drop panels 120 when the oxygen assemblies 108 are in stowed positions, as shown in FIG. 7.

The emergency oxygen system 100 is shown outboard from the PSUs 106. That is, the emergency oxygen system 100 is disposed closer to a sidewall 401 than the PSUs 106. Stowage bin assemblies 402 can be inboard from the PSUs 106. Optionally, the emergency oxygen system 100 can be inboard from the PSUs 106. The emergency oxygen system 100 is disposed over and/or to sides of seats 404 within the internal cabin 102.

The PSUs 106 can include attendant call buttons/lights 408, gaspers or passenger air outlets 410, and reading lights 412. For example, each PSU 106 includes a panel 414 that retains at least a portion of an attendant light 408, a gasper 410, and a reading light 412. In contrast, the oxygen system 100 does not include the PSUs 106, or portions thereof (such as the lights 408, gaspers 410, and reading lights 412).

FIG. 8 illustrates a perspective internal view of an internal cabin 102 of an aircraft 104, according to an embodiment of the present disclosure. The aircraft 104 can include a single aisle 500. Emergency oxygen systems 100 can be disposed to each side of the aisle 500. The emergency oxygen systems 100 extend along a length of the internal cabin 102.

Optionally, the internal cabin 102 can include multiple aisles. An emergency oxygen system 100 can be disposed above a center section of seats 404 between the aisles.

In at least one embodiment, an emergency oxygen system 100 can be secured to a ceiling 502 over the aisle 500. The emergency oxygen system 100 can be in addition to, or in place of, the emergency oxygen systems 100 shown proximate to the sidewalls 504.

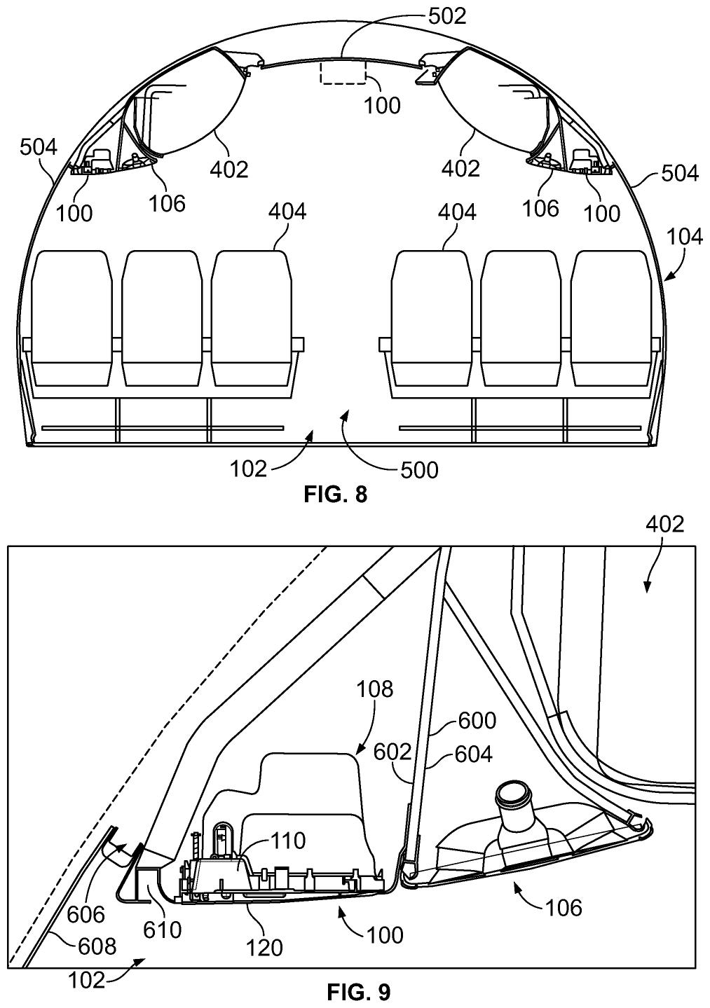

FIG. 9 illustrates an axial cross-sectional view of an oxygen assembly 108 of an emergency oxygen system 100 within an internal cabin 102, according to an embodiment of the present disclosure. As shown, the emergency oxygen system 100 is separate and distinct from the PSU 106. In at least one embodiment, a partition wall 600 separates the emergency oxygen system 100 from the PSUs 106. The oxygen assemblies 108 are mounted to a first side 602 of the partition wall 600, while the PSUs 106 are mounted to a second side 604 (opposite from the first side 602) of the partition wall 600.

As shown, the emergency oxygen system 100 is outboard in relation to the PSUs 106, which, in turn, can be outboard in relation to the stowage bin assemblies 402. A light fixture 606 can be disposed between a sidewall 608 and an environmental control system (ECS) 610, such as may include vents. The emergency oxygen system 100 can be disposed between the ECS 610 and the PSUs 106.

The emergency oxygen system 100 is separate from the PSUs 106 and the stowage bin assemblies 402. That is, neither the PSUs 106, nor the stowage bin assemblies 402, include the emergency oxygen system 100. The PSUs 106 can also be separate and distinct from the stowage bin assemblies 402.

In at least one embodiment, the emergency oxygen system 100 can extend along lengths of the internal cabin 102 that do not include stowage bin assemblies 402. Further, the positions of the emergency oxygen system 100 and the PSUs 106 can be switched, such that the PSUs 106 are outboard in relation to the emergency oxygen system 100.

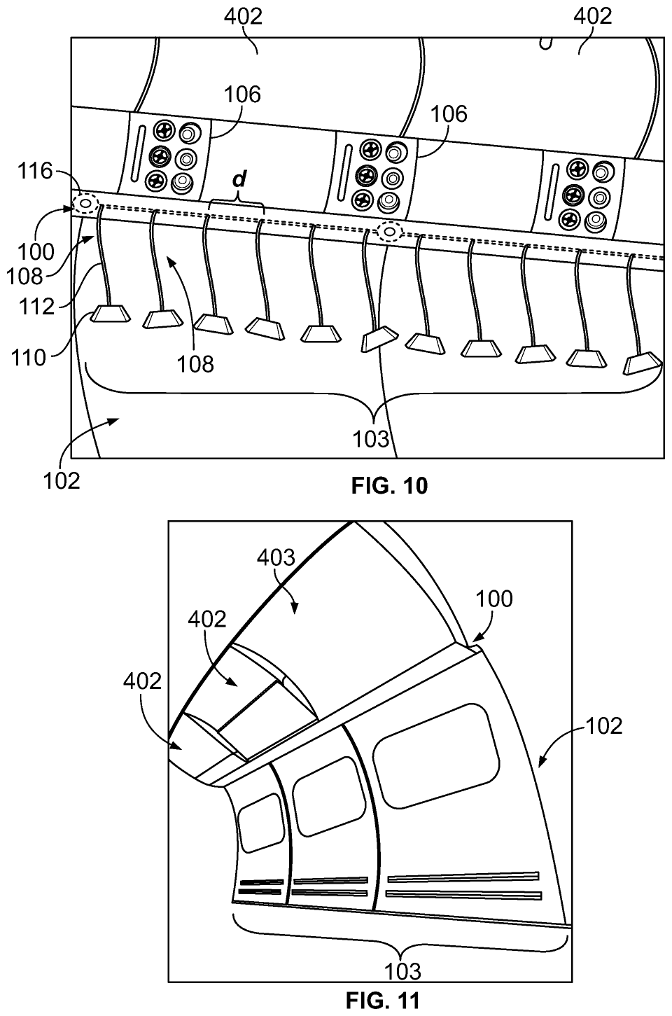

FIG. 10 illustrates a lateral view of the emergency oxygen system 100 within an internal cabin 102, according to an embodiment of the present disclosure. As shown, the oxygen assemblies 108 are in deployed positions (for example, dropped below oxygen assembly housings). The oxygen assemblies 108 are retained by the rail 116, which extends along a length 103 of the internal cabin 102.

The oxygen assemblies 108 are linearly arranged and spaced from one another. Neighboring (that is, closest) oxygen assemblies 108 are separated a distance d from one another. In at least one embodiment, the distance d is between 3-10 inches. For example, the distance d can be 5 inches. Spacing the oxygen assemblies 108 in such a manner ensures that the oxygen assemblies 108 are readily available for passengers within the internal cabin 102 regardless of seat pitch. That is, the oxygen assemblies 108 are not dependent upon seat pitch. Instead, the oxygen assemblies 108 are uncoupled from seat pitch.

FIG. 11 illustrates a perspective lateral view of the emergency oxygen system 100 within an internal cabin 102, according to an embodiment of the present disclosure. The emergency oxygen system 100 extends along the length 103, which may include areas having stowage bin assemblies 402, and areas 403 that are devoid of stowage bin assemblies 402. In at least one example, the internal cabin 102 may not include any stowage bins.

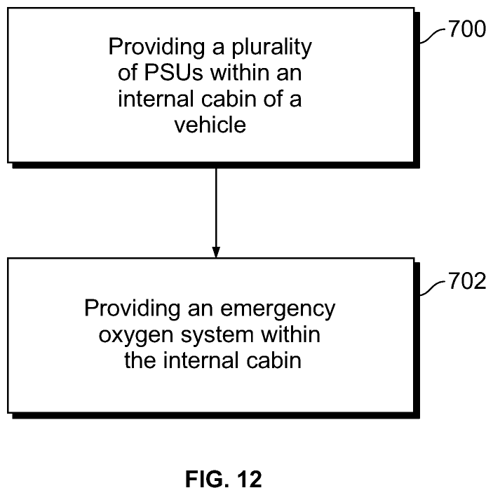

FIG. 12 illustrates a flow chart of a method, according to an embodiment of the present disclosure. Referring to FIGS. 1-12, the method includes providing, at 700, a plurality of passenger service units (PSUs) 106 within an internal cabin 102 of a vehicle 104; and providing, at 702, an emergency oxygen system 100 within the internal cabin 102, wherein the emergency oxygen system 100 is separate and distinct from the plurality of PSUs 106.

In at least one embodiment, the method also includes fluidly coupling an oxygen supply 114 with the plurality of oxygen assemblies 108. For example, said fluidly coupling includes fluidly coupling an oxygen canister 114a to the fluid conduit 112. That is, each oxygen assembly 108 can be coupled to its own respective oxygen canister 114a. As another example, said fluidly coupling includes fluidly coupling an oxygen tank 114b to the plurality of fluid conduits 112 via a manifold 400.

In at least one embodiment, the method also includes retaining the plurality of oxygen assemblies 108 by a rail 116 extending along a length 103 of the internal cabin 102.

In at least one embodiment, the method also includes disposing the emergency oxygen system 100 between a sidewall 504 of the vehicle 104 and the plurality of PSUs 106.

In at least one embodiment, the method also includes separating the emergency oxygen system 100 from the plurality of PSUs 106 by a partition wall 600.

In at least one embodiment, the method also includes disposing one or more of the plurality of PSUs 106 between one or more stowage bin assemblies 402 and the emergency oxygen system 100.

In at least one embodiment, a method includes installing an oxygen system separately from PSU and components of PSU. In at least one embodiment, the method includes installing the oxygen system independently from seat pitch.

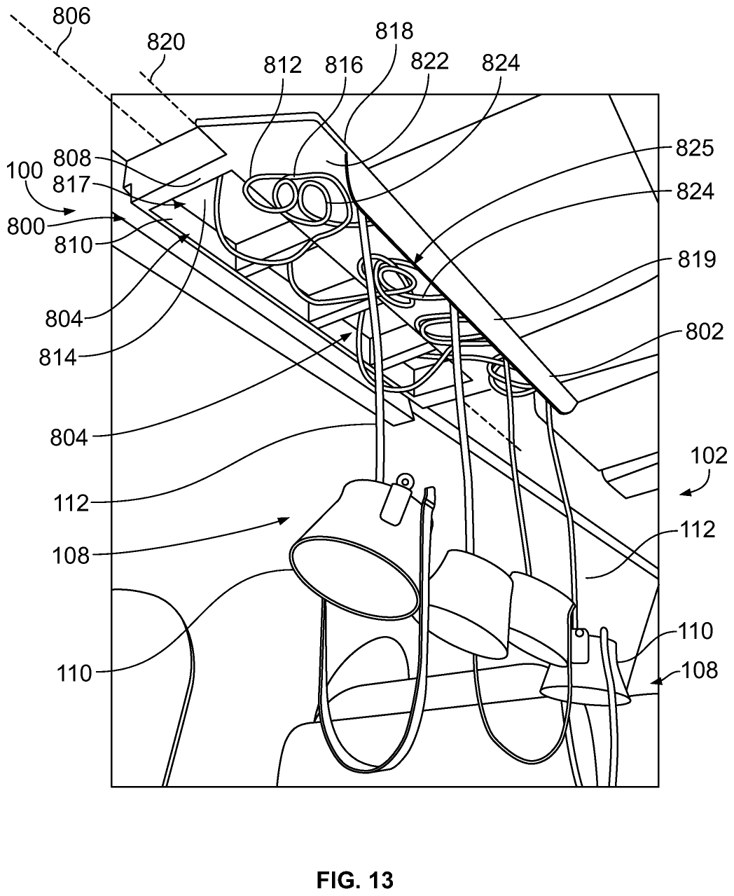

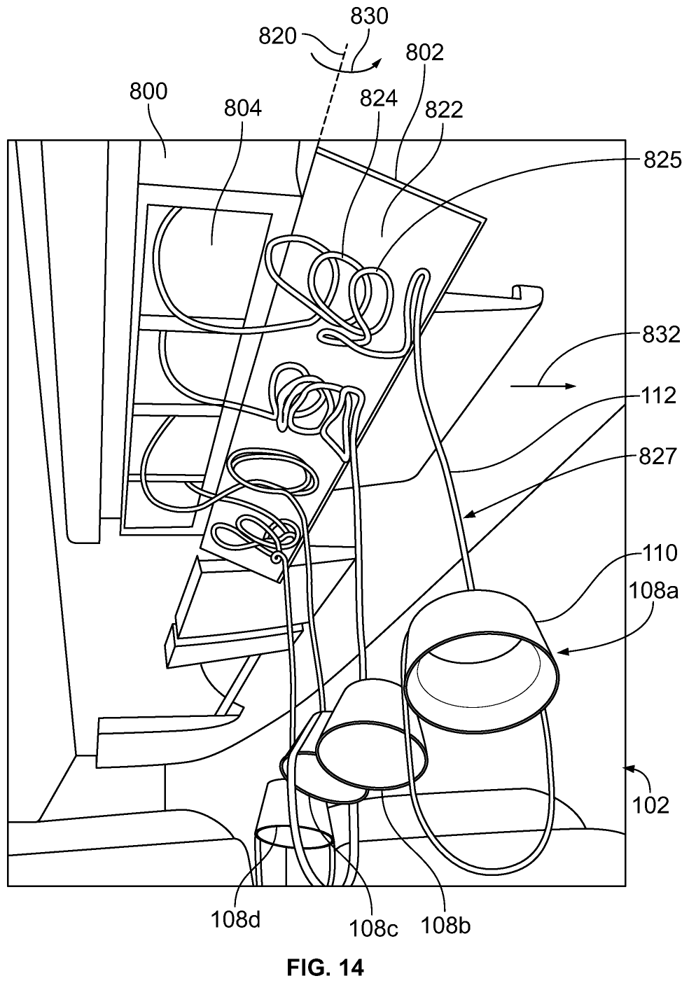

FIG. 13 illustrates a perspective lateral bottom view of an emergency oxygen system 100 having oxygen assemblies 108 in deployed positions, according to an embodiment of the present disclosure. FIG. 14 illustrates a perspective bottom view of the emergency oxygen system 100 of FIG. 13 having the oxygen assemblies 108 in the deployed positions. Referring to FIGS. 13 and 14, in at least one example, the emergency oxygen system 100 includes a housing 800 and a door 802 moveably secured to the housing 800. The housing 800 can be secured to a rail 116 (shown in FIG. 1, for example). Optionally, the housing 800 may form the rail 116.

The housing 800 includes one or more compartments 804 configured to retain the oxygen assemblies 108 in stowed positions. As shown, the housing 800 can include four or more compartments 804 arranged along a line 806. As such, the compartments 804 are linearly arranged. The housing 800 may include more compartments 804 than shown. For example, the housing 800 may include five, six, or more compartments 804. As another example, the housing 800 may include three or less compartments 804. In at least one example, the housing 800 includes a single compartment 804.

Each compartment 804 includes a fore wall 808 connected to an outboard wall 810, an inboard wall 812, and a top wall 814. An aft wall 816 connects to the outboard wall 810, the inboard wall 812, and the top wall 814 opposite from the fore wall 808. An interior chamber 817 is defined between the fore wall 808, the outboard wall 810, the inboard wall 812, and the top wall 814.

The door 802 includes a covering panel 818, which can be connected to an edge lip 819. The edge lip 819 can be canted in relation to the covering panel 818. The door 802 is moveably secured to the housing 800. For example, the door 802 is pivotally coupled to the housing 800 via a pivot axle 820. The door 802 is pivotally coupled to the housing at an inboard surface, such as on and/or within the inboard walls 812 of the compartments 804.

An interior surface 822 of the covering panel 818 includes one or more clips configured to retain portions of the fluid conduits 112. For example, the clips retain tubing 824 of the fluid conduits 112.

The oxygen assemblies 108 are secured in stowed positions, such as shown in FIG. 11. In the stowed positions, the door 802 is closed and secured underneath the compartments 804. The door 802 in the closed position has the edge lip 819 secured to or on an outboard surface of the housing 800, such as on or within the outboard walls 810 of the compartments 804. When the door 802 is in the closed position, the oxygen assemblies 108 are in stowed positions. In the stowed positions, the tubing 824 of the fluid conduits 112 can be secured by the clips, which can allow the slack 825 of the tubing 824 to be spooled, coiled, looped, and/or the like. In this manner, the clips neatly, effectively, and efficiently retain the tubing 824. In the stowed positions, the masks 110 and the tubing 824 can rest on top of the interior surface 822 of the covering panel 818.

In response to a deployment event, the door 802 swings open by pivoting inboard toward an aisle of an internal cabin in the direction of arc 830 about the pivot axle 820. As the door 802 swings into an open position, the slack 825 of the fluid conduits 112 follows, as the slack 825 is secured to the interior 822 of the door 802. Consequently, as the door 802 opens, the masks 110 fall out of the compartments 804, but are laterally moved (such as inwardly moved in an inboard direction 832) due to hanging from the free edge (for example, the edge lip 819) of the door, by extending from the slack 825 proximate to the edge lip 819. By deploying the masks 110 in the direction 832 as the masks 110 fall out of the compartments 804, the masks 110 are more readily accessible and easier to grasp by individuals seated within the internal cabin 102.

As an individual pulls one of the masks 110, such as that of the oxygen assembly 108a, the slack 825 within the clips secured to the door 802 is decreased, as the dangling portion 827 of the tubing 824 increases toward the individual. In at least one example, the pulling of the dangling portion 827 of the tubing 824 does not affect the other oxygen assemblies 108b, 108c, and 108d. In particular, the tubing 824 of the oxygen assemblies 108a-108d is not connected. As such, movement of the fluid conduit 112 of one oxygen assembly 108a, b, c, or d, does not affect the other oxygen assemblies 108a, b, c, or d. Alternatively, tubing of different oxygen assemblies may be connected.

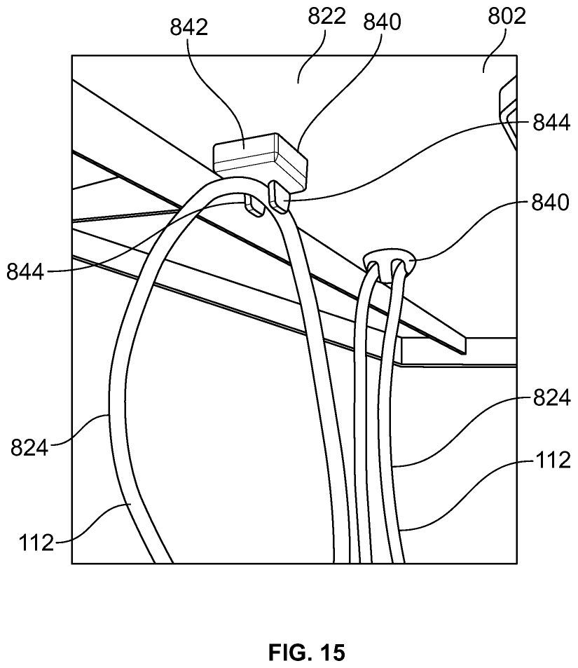

FIG. 15 illustrates a perspective bottom view of the door 802 in an open position, according to an embodiment of the present disclosure. Referring to FIGS. 13-15, the interior surface 822 of the door 802 includes clips 840 secured thereto. The clips 840 are secured in relation to each compartment 804. Each clip 840 includes a base 842 secured to the interior surface 822, and flexible retaining prongs 844 that are configured to removably secure around exterior surfaces of the tubing 824 of a fluid conduit 112. In this manner, the clips 840 are configured to retain the tubing 824 to take up slack, and provide a neat, efficient, and effective system for ensuring that excess slack of the fluid conduits 112 is moved away from the compartments 804 when the door 802 is in the open position. In this manner, portions of the fluid conduits 112 are secured to the door 802, which allows the masks 110 to be moved laterally in the direction of arrow 832 during deployment. Further, by securing the slack 825 of the fluid conduits 112 away from the compartments 804, the oxygen assemblies 108 are more easily packed and repacked into the compartments 804 when the door 802 is in the open position, as the excess slack 825 does not form an obstruction within the compartments 804.

The clips 840 allow most of the tubing 824 of the fluid conduit 112 to be held on the door 802. In this manner, the clips 840 allow for a neat and effective organization of the oxygen assemblies 108. Further, the clips 840 reduce a potential of the tubing tangling. Also, the clips 840 allow for easier packing and repacking of the oxygen assemblies 108 within the compartments 804 by providing a clearer path into the compartments 804.

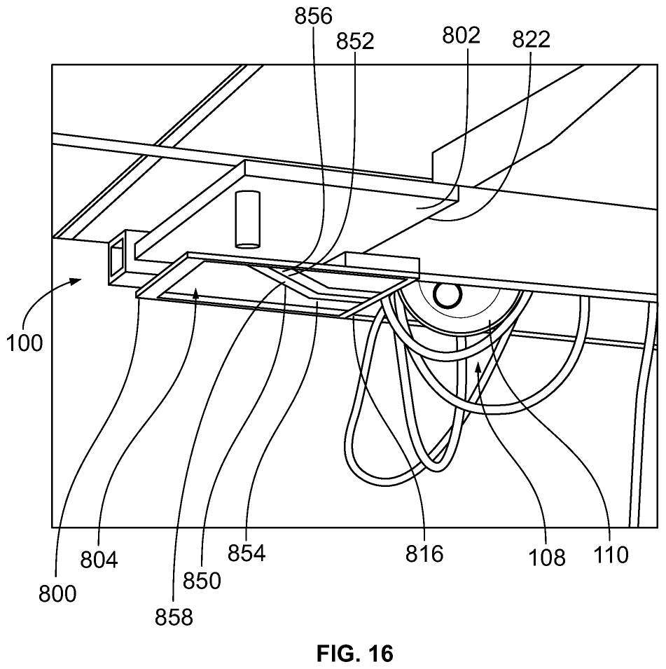

FIG. 16 illustrates a perspective lateral bottom view of an open compartment 804, according to an embodiment of the present disclosure. A retainer 850 can be moveably secured within each compartment 804. The retainer 850 is configured to be moved between a retaining position and a disengaged position. In at least one example, the retainer 850 is a moveable arm 852, which is pivotally secured to a portion of the compartment 804. For example, the moveable arm 852 includes an end 854 pivotally coupled to the aft wall 816, the top wall 814, or other walls as shown and described with respect to FIG. 13. The end 854 connects to a free end 856 by an intermediate body 858.

As shown in FIG. 16, the retainer 850 is in a retaining position, in which the intermediate body 858 spans across a portion of the compartment 804. When the oxygen assemblies 108 are packed or repacked into the compartments 804, the retainers 850 are pivoted into the disengaged positions, so that there are clear paths into the compartments 804. As such, an individual may then position the masks 110 into the compartments 804. After a mask 110 is placed into a respective compartment 804, the individual then pivots the retainer 850 into the retaining position underneath the mask 110 so that the mask 110 does not fall out of the compartment 804. Once all the masks 110 are positioned in the compartments 804 and held in position by the retainer 850 in the retaining positions, the door 802 is then closed underneath the masks 110. As the door 802 is closed, one or more portions (such as edges, protuberances, or the like) of the door 802 may then abut into portions of the retainers 850 and move the retainers 850 back to disengaged positions (in which they are not underneath the masks 110). As such, the masks 110 are then supported on the interior surface 822 of the door 802, and are then able to fall out of the compartments 804 when the door 802 swings open during a deployment event.

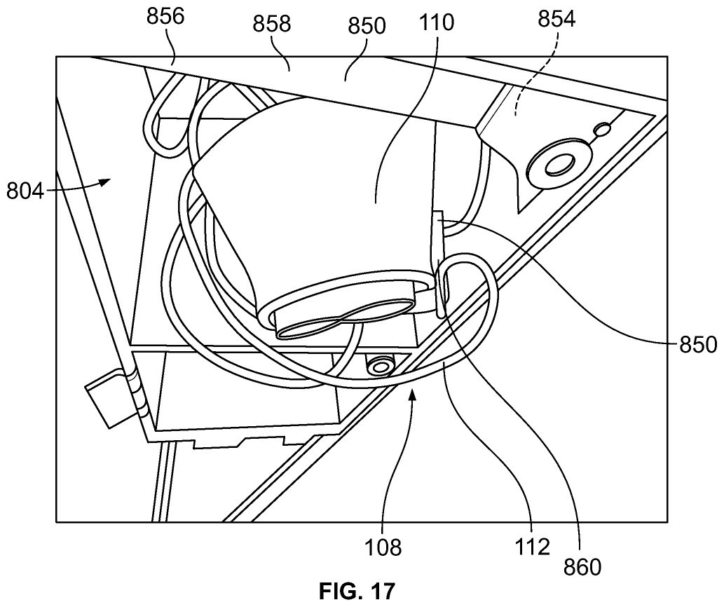

FIG. 17 illustrates a perspective fore bottom view of the open compartment 804. As shown, an oxygen assembly 108 is being packed into the compartment 804. The retainer 850 is in the disengaged position in FIG. 17, such that the retainer 850 is not underneath the mask 110 temporarily holding the mask 110 within the compartment 804.

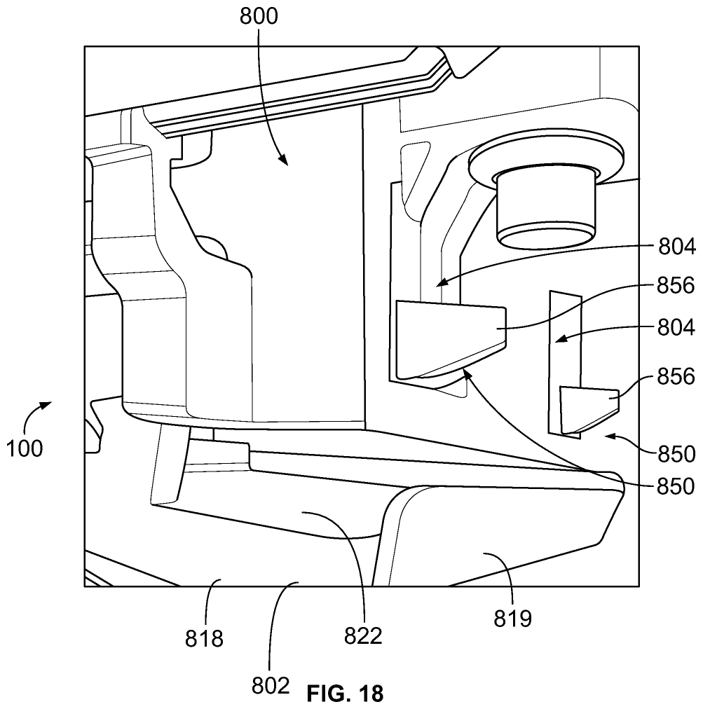

FIG. 18 illustrates a perspective end view of an emergency oxygen system 100, according to an embodiment of the present disclosure. As shown in FIG. 18, the door 802 is not fully closed. Referring to FIGS. 13-18, the retainers 850 are in retaining positions such that the intermediate body 856 are underneath the masks 110, thereby temporarily supporting the masks 110 (which allows for easier packing and repacking of the oxygen assemblies 108 when the door 802 is in the open position). As the door 802 is closed, the lip 819 is moved into the free ends 856 and forces the retainers 850 to pivot back to disengaged positions, so that the masks 110 are supported only on the interior surface 822 of the door 802 (thereby allowing the masks 110 to drop out of the compartments 804 as the door 802 opens during a deployment event).

Referring again to FIG. 17, instead of (or in addition to) a moveable arm, the retainer 850 may be or otherwise include a snap clip 860. The snap clip 860 is secured to an interior wall portion of the compartment 804, and is configured to snapably retain a portion of the mask 110 (such as a reciprocal protuberance). In this manner, the snap clip 860 can temporarily secure the mask 110 within the compartment 804. Referring to FIGS. 17 and 18, as the door 802 is closed, the interior surface 822 of the door 802 pushes the mask 110 upwardly, and disengages the portion of the mask 110 from the snap clip 860, thereby ensuring that the mask 110 is supported by the interior surface 822 of the door 802, and no longer by the snap clip 860.

In at least one example, the retainer 850 can include the moveable arm and a snap clip. The retainer 850 can optionally be or include various other structures. For example, the retainer 850 can be or include a magnet. As another example, the retainer 850 can be or include a hook-and-loop fastener. In a retaining position, the retainer 850 is configured to temporarily secure the mask 110 within the compartment 804. In the disengaged position, the retainer 850 does not secure the mask 110 within the compartment 804.

Referring to FIGS. 1-17, embodiments of the present disclosure provide emergency oxygen systems 100 having oxygen assemblies 108 that are uncoupled from PSUs 106. The oxygen assemblies 108 can be linearly arranged over seats within an internal cabin. Separating the emergency oxygen system 100 from the PSU 106 allows the oxygen assemblies to be linearly arranged within the internal cabin, and also allows components of the PSU 106 to be more easily updated and/or replaced. The linear arrangement of the masks 110 provides any passenger access to an emergency oxygen drop regardless of the seat pitch, location, type of seat, or position of seat (for example, bed position of a lie-flat seat) within an internal cabin. The emergency oxygen systems 100 described herein provide for efficient and effective stowage, deployment, packing, and repacking of oxygen assemblies 100 in relation to compartments 804. The systems and methods described provide intuitive operation for passengers, as well as personnel tasked with packing and repacking the oxygen assemblies 100.

As described herein, in at least one example, the emergency oxygen system 100 is for an internal cabin 102 of a vehicle, such as an aircraft 104. The emergency oxygen system 100 includes a housing 800 including one or more compartments 804, and one or more oxygen assemblies 108. Each of the one or more oxygen assemblies 108 include a mask 110 and a fluid conduit, 112. The mask(s) 110 is configured to be stowed within and deployed from the compartment(s) 804. A door 802 is moveably secured to the housing 800. The door 802 is moveable between a closed position underneath the compartment(s) 804 to secure the mask(s) 110 within the compartment(s) 804, and an open position during a deployment event in which the mask(s) 110 drops down and inboard, for example, (in the direction of arrow 832) out of the compartment(s) 804. As shown in FIGS. 13 and 14, in particular, the mask(s) 110 hangs down from a portion of the door 802 (for example, a free portion, such as the edge lip 819) when the door 802 is in the open position. In at least one example, the door 802 is configured to rotate between the closed position and the open position, such as about the pivot axle 820.

In at least one example, a least a portion of the fluid conduit 112 is secured to the interior surface 822 of the door 802. For example, the door includes one or more clips 840 secured to the interior surface 822. At least a portion of the fluid conduit 112 (such as slack portions of tubing 824) is secured to the interior surface 822 of the door 802 by the clip(s) 840.

In at least one example, one or more retainers 850 are coupled to the compartment(s) 804. The retainer(s) 850 is moveable between a retaining position in which the retainer(s) 850 temporarily support the mask(s) 110 within the compartment(s) 804 when the door 802 is open, and a disengaged position in which the retainer(s) 850 do not support the mask(s) 110 within the compartment(s) 804. In at least one example, a portion of the door 802 moves the retainer(s) 850 from the retaining position to the disengaged position when the door 802 moves into the closed position. In at least one example, the retainer(s) 850 include one or more arms 852 pivotally coupled to one or more portions of the compartment(s) 804. As another example, the retainer(s) 850 include one or more snap clips 860.

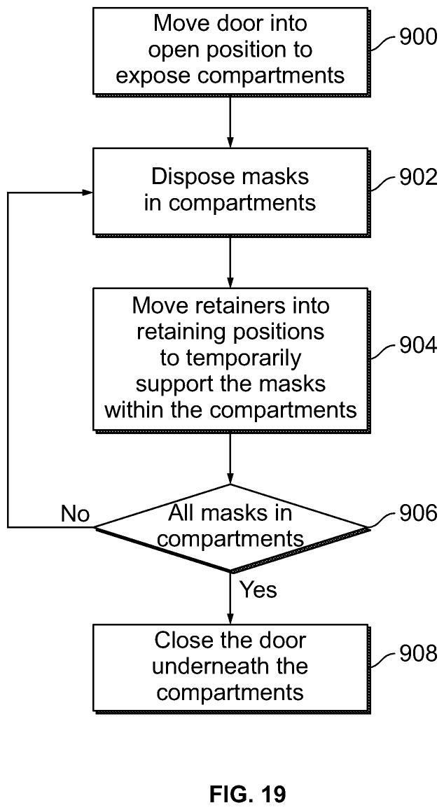

FIG. 19 illustrates a flow chart of a method, according to an embodiment of the present disclosure. Referring to FIGS. 1-9, at 900, a door 802 of an emergency oxygen system 100 can be moved into an open position, thereby exposing one or more compartments 804. At 902, masks 110 of oxygen assemblies 108 are disposed in the open compartments 802 (with at least portions of tubing 824 of the fluid conduits 112 secured to the door 804 by clips 840). At 904, after a mask 110 is positioned within a respective compartment 804, a retainer 850 is moved into a retaining position to temporarily support the mask 110 within the compartment 804. At 906, it is determined if all masks 110 are in respective compartments 804. If not, the method returns to 902. If, however, all the masks 110 are in the respective compartments 804 and temporarily supported by the retainers 850, the door 802 is closed underneath the compartments at 908. As the door 802 moves into the closed position, one or more portions of the door 802 engage one or more portions of the retainers 850 to move the retainers 850 into disengaged positions (in which the masks 110 are no longer supported by the retainers 850), such that the masks 110 are supported on the interior surface 822 of the door 802. In this manner, as the door 802 is opened during a deployment event, the masks 110 are able to drop downwardly (and in the direction 832) out of the compartments 804.

Further, the disclosure comprises embodiments according to the following clauses:

Clause 1. An emergency oxygen system for an internal cabin of a vehicle, the emergency oxygen system comprising:
a housing including one or more compartments;
one or more oxygen assemblies, wherein the one or more oxygen assemblies include a mask and a fluid conduit, wherein the mask is configured to be stowed within and deployed from the one or more compartments; and
a door moveably secured to the housing, wherein the door is moveable between a closed position underneath the one or more compartments to secure the mask within the one or more compartments, and an open position during a deployment event in which the mask drops down and laterally out of the one or more compartments, and wherein the mask is configured to hang down from a portion of the door when the door is in the open position.

Clause 2. The emergency oxygen system of Clause 1, wherein the door is configured to rotate between the closed position and the open position.

Clause 3. The emergency oxygen system of Clauses 1 or 2, wherein the mask is supported on the interior surface of the door when the door is in the closed position.

Clause 4. The emergency oxygen system of any of Clauses 1-3, wherein at least a portion of the fluid conduit is secured to an interior surface of the door.

Clause 5. The emergency oxygen system of Clause 4, wherein the door includes one or more clips secured to the interior surface, and wherein the at least a portion of the fluid conduit is secured to the interior surface of the door by the one or more clips.

Clause 6. The emergency oxygen system of any of Clauses 1-5, further comprising one or more retainers coupled to the one or more compartments, wherein the one or more retainers are moveable between a retaining position in which the one or more retainers temporarily support the mask within the one or more compartments when the door is the open position, and a disengaged position in which the one or more retainers do not support the mask within the one or more compartments.

Clause 7. The emergency oxygen system of Clause 6, wherein a portion of the door moves the one or more retainers from the retaining position to the disengaged position when the door moves into the closed position.

Clause 8. The emergency oxygen system of Clauses 6 or 7, wherein the one or more retainers comprise one or more arms pivotally coupled to one or more portions of the one or more compartments.

Clause 9. The emergency oxygen system of any of Clauses 6-8, wherein the one or more retainers comprise one or more snap clips.

Clause 10. The emergency oxygen system of any of Clauses 1-9, wherein the one or more compartments comprise a plurality of compartments, and wherein the one or more oxygen assemblies comprise a plurality of oxygen assemblies.

Clause 11. A method comprising:
stowing a mask of one or more oxygen assemblies within one or more compartments of a housing of an emergency oxygen system; and
moving a door secured to the housing between a closed position underneath the one or more compartments to secure the mask within the one or more compartments, and an open position during a deployment event in which the mask drops down and laterally out of the one or more compartments, and wherein the mask is configured to hang down from a portion of the door when the door is in the open position.

Cause 12. The method of Clause 11, wherein said moving comprises rotating the door between the closed position and the open position.

Clause 13. The method of Clause 12, further comprising supporting the mask on an interior surface of the door when the door is in the closed position.

Clause 14. The method of any of Clauses 11-13, further comprising securing, by at least one or more clips, at least a portion of a fluid conduit of the one or more oxygen assemblies to the interior surface of the door.

Clause 15. The method of any of Clauses 11-14, further comprising moving one or more retainers coupled to the one or more compartments between a retaining position in which the one or more retainers temporarily support the mask within the one or more compartments when the door is in the open position, and a disengaged position in which the one or more retainers do not support the mask within the one or more compartments.

Clause 16. The method of Clause 15, wherein said moving comprises moving, by a portion of the door, the one or more retainers from the retaining position to the disengaged position when the door moves into the closed position.

Clause 17. A vehicle, comprising:
an internal cabin; and
an emergency oxygen system within the internal cabin, wherein the emergency oxygen system comprises:
   a housing including one or more compartments;
   one or more oxygen assemblies, wherein the one or more oxygen assemblies include a mask and a fluid conduit, wherein the mask is configured to be stowed within and deployed from the one or more compartments;
   a door moveably secured to the housing, wherein the door is moveable between a closed position underneath the one or more compartments to secure the mask within the one or more compartments, and an open position during a deployment event in which the mask drops down and laterally out of the one or more compartments, wherein the mask is supported on an interior surface of the door when the door is in the closed position, wherein the mask is configured to hang down from a portion of the door when the door is in the open position, wherein one or more clips secure at least a portion of the fluid conduit to the interior surface of the door; and
   one or more retainers coupled to the one or more compartments, wherein the one or more retainers are moveable between a retaining position in which the one or more retainers temporarily support the mask within the one or more compartments when the door is in the open position, and a disengaged position in which the one or more retainers do not support the mask within the one or more compartments, and wherein a portion of the door moves the one or more retainers from the retaining position to the disengaged position when the door moves into the closed position.

Clause 18. The vehicle of Clause 17, wherein the door is configured to rotate between the closed position and the open position.

Clause 19. The vehicle of Clauses 17 or 18, wherein the one or more retainers comprise one or more arms pivotally coupled to one or more portions of the one or more compartments.

Clause 20. The vehicle of any of Clauses 17-19, wherein the one or more compartments comprise a plurality of compartments, and wherein the one or more oxygen assemblies comprise a plurality of oxygen assemblies.

As described herein, embodiments of the present disclosure provide systems and methods for freeing up space within PSUs. Further, embodiments of the present disclosure provide systems and methods that ensure emergency oxygen assemblies are easily and readily available within an internal cabin of an aircraft even if seats within the internal cabin are reconfigured. The emergency oxygen systems and methods described herein reduce time and labor costs associated with manufacture and reconfiguration of internal cabins of aircraft, as there is no need to adjust mounting positions for oxygen assemblies (which were previously within PSUs).

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third.” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An emergency oxygen system for an internal cabin of a vehicle, the emergency oxygen system comprising:
a housing including one or more compartments;
one or more oxygen assemblies, wherein the one or more oxygen assemblies include a mask and a fluid conduit, wherein the mask is configured to be stowed within and deployed from the one or more compartments; and
a door moveably secured to the housing, wherein the door is moveable between a closed position underneath the one or more compartments to secure the mask within the one or more compartments, and an open position during a deployment event in which the mask drops down and laterally out of the one or more compartments, and wherein the mask is configured to hang down from a portion of the door when the door is in the open position.

2. The emergency oxygen system of claim 1, wherein the door is configured to rotate between the closed position and the open position.

3. The emergency oxygen system of claim 1, wherein the mask is supported on an interior surface of the door when the door is in the closed position.

4. The emergency oxygen system of claim 1, wherein at least a portion of the fluid conduit is secured to an interior surface of the door.

5. The emergency oxygen system of claim 4, wherein the door includes one or more clips secured to the interior surface, and wherein the at least a portion of the fluid conduit is secured to the interior surface of the door by the one or more clips.

6. The emergency oxygen system of claim 1, further comprising one or more retainers coupled to the one or more compartments, wherein the one or more retainers are moveable between a retaining position in which the one or more retainers temporarily support the mask within the one or more compartments when the door is the open position, and a disengaged position in which the one or more retainers do not support the mask within the one or more compartments.

7. The emergency oxygen system of claim 6, wherein a portion of the door moves the one or more retainers from the retaining position to the disengaged position when the door moves into the closed position.

8. The emergency oxygen system of claim 6, wherein the one or more retainers comprise one or more arms pivotally coupled to one or more portions of the one or more compartments.

9. The emergency oxygen system of claim 6, wherein the one or more retainers comprise one or more snap clips.

10. The emergency oxygen system of claim 1, wherein the one or more compartments comprise a plurality of compartments, and wherein the one or more oxygen assemblies comprise a plurality of oxygen assemblies.

11. A method comprising:
stowing a mask of one or more oxygen assemblies within one or more compartments of a housing of an emergency oxygen system; and
moving a door secured to the housing between a closed position underneath the one or more compartments to secure the mask within the one or more compartments, and an open position during a deployment event in which the mask drops down and laterally out of the one or more compartments, and wherein the mask is configured to hang down from a portion of the door when the door is in the open position.

12. The method of claim 11, wherein said moving comprises rotating the door between the closed position and the open position.

13. The method of claim 11, further comprising supporting the mask on an interior surface of the door when the door is in the closed position.

14. The method of claim 11, further comprising securing, by at least one or more clips, at least a portion of a fluid conduit of the one or more oxygen assemblies to an interior surface of the door.

15. The method of claim 11, further comprising moving one or more retainers coupled to the one or more compartments between a retaining position in which the one or more retainers temporarily support the mask within the one or more compartments when the door is in the open position, and a disengaged position in which the one or more retainers do not support the mask within the one or more compartments.

16. The method of claim 15, wherein said moving comprises moving, by a portion of the door, the one or more retainers from the retaining position to the disengaged position when the door moves into the closed position.

17. A vehicle, comprising:
an internal cabin; and
an emergency oxygen system within the internal cabin, wherein the emergency oxygen system comprises:
a housing including one or more compartments;
one or more oxygen assemblies, wherein the one or more oxygen assemblies include a mask and a fluid conduit, wherein the mask is configured to be stowed within and deployed from the one or more compartments;
a door moveably secured to the housing, wherein the door is moveable between a closed position underneath the one or more compartments to secure the mask within the one or more compartments, and an open position during a deployment event in which the mask drops down and laterally out of the one or more compartments, wherein the mask is supported on an interior surface of the door when the door is in the closed position, wherein the mask is configured to hang down from a portion of the door when the door is in the open position, wherein one or more clips secure at least a portion of the fluid conduit to the interior surface of the door; and
one or more retainers coupled to the one or more compartments, wherein the one or more retainers are moveable between a retaining position in which the one or more retainers temporarily support the mask within the one or more compartments when the door is in the open position, and a disengaged position in which the one or more retainers do not support the mask within the one or more compartments, and wherein a portion of the door moves the one or more retainers from the retaining position to the disengaged position when the door moves into the closed position.

18. The vehicle of claim 17, wherein the door is configured to rotate between the closed position and the open position.

19. The vehicle of claim 17, wherein the one or more retainers comprise one or more arms pivotally coupled to one or more portions of the one or more compartments.

20. The vehicle of claim 17, wherein the one or more compartments comprise a plurality of compartments, and wherein the one or more oxygen assemblies comprise a plurality of oxygen assemblies.
